(19) United States
(12) Patent Application Publication
(10) Pub. No.: US 2009/0139744 A1
(43) Pub. Date: Jun. 4, 2009

(54) Small-Diameter Wireline Cables and Methods of Making Same

(76) Inventors: Joseph Varkey, Sugar Land, TX (US); Vladimir Hernandez-Solis, Stafford, TX (US); Jose Ramon Lozano-Gendreau, Stafford, TX (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/277,693

(22) Filed: Nov. 25, 2008

Related U.S. Application Data
(60) Provisional application No. 60/991,273, filed on Nov. 30, 2007.

(51) Int. Cl. H01B 7/00; H01R 43/00

(52) U.S. Cl. 174/113 R; 29/825

(57) ABSTRACT

A small-diameter wireline cable core has either two insulated preferably half moon profile conductors fixed together or an insulated central conductor over which three insulated conductors are helically cabled in a triad configuration. A layer of polymeric insulator covers all of the conductors to form a circular profile. A cable is formed by counterhelically cabling at least two layers of bare armor wire strength members over the cable core and encasing the strength members in one of layers of pure polymer, layers of short-fiber-reinforced polymer, and alternating layers of pure and short-fiber-reinforced polymer.

### CROSS-REFERENCE TO RELATED APPLICATION

This application is entitled to the benefit of, and claims priority to, provisional patent application Ser. No. 60/991,273 filed Nov. 30, 2007, the entire disclosure of which is incorporated herein by reference.

### BACKGROUND

The statements in this section merely provide background information related to the present disclosure and may not constitute prior art.

Embodiments of cables relate generally to cables for transmitting electrical current and, in particular, to small diameter wireline cables and methods of making and using such cables.

In oilfield applications requiring small-diameter wireline cables, two basic designs are currently used; monocables and coaxial cables. Monocables use a single insulated copper conductor at the core for both electrical transmission and telemetry functions. With prior art monocables, the signals are transmitted down the central, insulated power conductor and return along on the metallic armor wire strength members at the outside of the cable. With prior art coaxial cables, the signals are transmitted down a central, insulated conductor, and return along a layer of stranded copper wires covered by a thin layer of polymeric insulation located near the outer edge of the cable core.

Prior art monocables are subject to the following problems. The use of the external armor wires as a pathway for the return signal creates a potential electrical shock hazard. Further, the amount of power that can be transmitted is limited depending on the type of armor wire used. While standard galvanized improved plow steel (GIPS) armor wires have a fairly low resistance, armor wires composed of MP or high-carbon alloys (as may be used in wells with a presence of H₂S) can have up to 20 times the resistance to electrical current.

Telemetry also suffers in prior art monocables because armor wires are highly magnetic, which leads to very high inductance values. This results in high levels of signal attenuation, which increase the further the signal travels. Telemetry on prior art monocables, therefore, is feasible only for shallow wells.

There is shown in FIGS. 1A and 1B common potential failures associated with prior art coaxial cables. As shown in FIG. 1A, a typical coaxial cable 10 has a core formed from a central, multi-stand conductor 11 encircled by a layer of stranded copper shielding wires 12, and the core is encircled by metallic armor wire strength members 13 at the outside of the cable. The conductor 11 and the wires 12 are embedded in a polymeric insulation 14. The wires 12 are separated from the strength members 13 by a thin layer 15 of polymeric insulation that is preferably different from the polymeric insulation 14 and is located at the outer edge of the cable core. As shown in FIG. 1B, damage 16 to the insulation layer 15 allows the shielding wires 12 to contact the armor wires 13, creating monocable-like electrical current transmission conditions.

Thus, a need exists for small diameter cables that overcome the problems encountered with current monocable and coaxial cable designs.

### SUMMARY

An embodiment of the method of forming a small-diameter wireline cable core includes: providing at least a pair of half moon profile conductors; extruding a layer of polymeric insulation over each of the conductors; fixing the layered conductors together with a fixing material to create one of an oval profile and a circular profile; and extruding a layer of polymeric insulation to form a cable core with a circular profile. The conductors can have a full half-circle profile or a short arc profile. The fixing material can be cabling tape or a polymeric insulation. The conductors can be formed from a copper material. The conductors each can include a plurality of conductive wires formed into a half moon profile.

Another embodiment of the method of forming a small-diameter wireline cable core includes: providing a stranded central conductor insulated with a soft polymer material; helically cabling three insulated conductors over the central conductor in a triad configuration; cabling three un-insulated conductors into spaces at an outside of the insulated conductors to form a plurality of bundled conductors; and extruding a layer of polymeric insulation over the plurality of bundled conductors to form the cable core. The soft polymer material on the central conductor deforms to fill interstitial voids between the central conductor and the insulated conductors. The stranded central conductor can be formed from a copper material.

The above-described methods further can include completing a cable including the cable core. The completing comprises counterhelically cabling at least two layers of bare armor wire strength members over the cable core. The completing further comprises encasing the armor wire strength members in one of layers of pure polymer, layers of short-fiber-reinforced polymer, and alternating layers of pure and short-fiber-reinforced polymer.

A small-diameter wireline cable core includes one of either two insulated half moon profile conductors fixed together or an insulated central conductor over which three insulated conductors are helically cabled in a triad configuration, and a layer of polymeric insulator covering all of the conductors to form a circular profile. The two insulated half moon profile conductors are fixed together with cabling tape. The cable core can include three un-insulated conductors cabled into spaces at an outside of the insulated conductors to form a plurality of bundled conductors.

An electrical cable includes the cable core and further comprises at least two layers of bare armor wire strength members counterhelically cabled over said cable core. The armor wire strength members are encased in one of layers of pure polymer, layers of short-fiber-reinforced polymer, and alternating layers of pure and short-fiber-reinforced polymer.

### BRIEF DESCRIPTION OF THE DRAWINGS

These and other features and advantages will be better understood by reference to the following detailed description when considered in conjunction with the accompanying drawings wherein:

FIGS. 1A and 1B are a radial cross-sectional views of a prior art coaxial cable;

FIG. 2 is a radial cross-sectional view of a two conductor wireline cable core according to a first embodiment;

FIGS. 3A through 3E are radial cross-sectional views of a two conductor wireline cable core according to a second embodiment;

FIGS. 4A and 4B are radial cross-sectional views of a two conductor wireline cable core according to a third embodiment;

FIG. 5 is a radial cross-sectional view of a two conductor wireline cable core according to a fourth embodiment;

FIG. 6 is a radial cross-sectional view of a two conductor wireline cable core according to a fifth embodiment;

FIGS. 7A through 7D are radial cross-sectional views of a triad conductor wireline cable core according to a sixth embodiment;

FIGS. 8A through 8D are radial cross-sectional views of alternative embodiments of a cable incorporating the triad conductor wireline cable core shown in FIG. 7D; and

FIGS. 9A through 9D are radial cross-sectional views of alternative embodiments of a cable incorporating the two conductor wireline cable core shown in FIG. 3E.

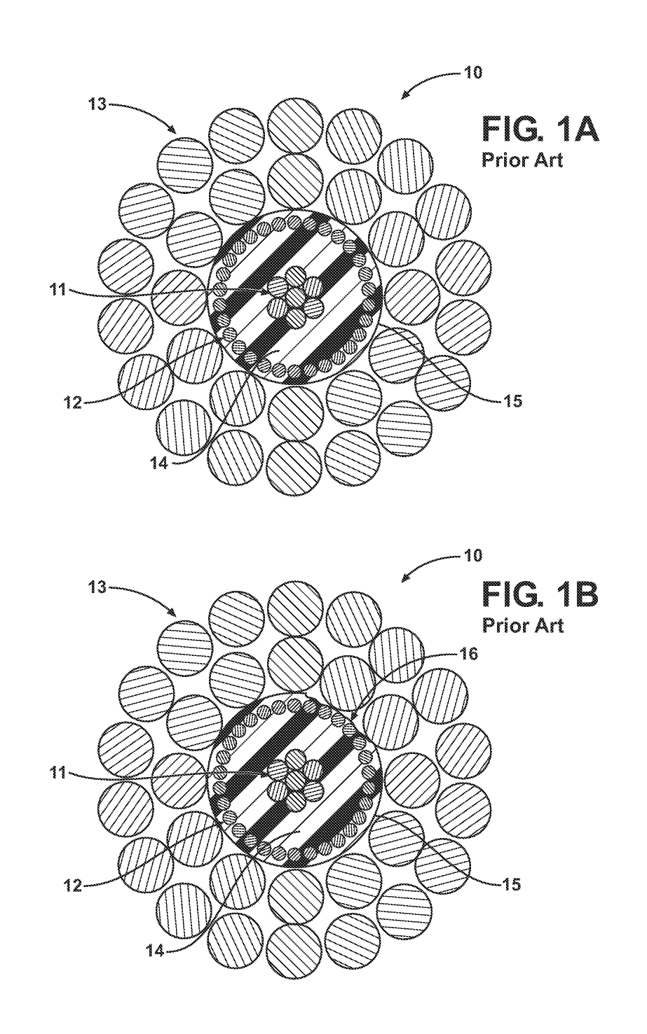

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

In a first embodiment of a cable core, shown in FIG. 2, the standard single insulated conductor or central insulated conductor is replaced with two half-moon profile insulated conductors. This embodiment or configuration allows relatively high amounts of power to be transmitted down one conductor and return on the other, while allowing ample room in the cross section for insulation to minimize the risk of electrical shorts. The symmetrical configuration is also advantageous for telemetry functions. The cable core may be operable to transmit power and/or telemetry at a rate of about two times the rate of a conventional or typical coaxial cable, depending on the diameter of the cable core, voltage ratings, etc.

As shown in FIG. 2, a core conductor 20 is formed from two half-moon profile copper conductors 21, 22 that are individually surrounded by insulation 23, 24 respectively. When the insulated conductors 21, 22 are positioned with the flat surfaces facing, the resulting profile is oval. An additional surrounding layer of insulation 25, typically an extrusion, is applied to the abutting conductors 21, 22 to form a circular profile.

Embodiments of cables include a small diameter high power cable core having half-moon profile conductors. An embodiment of a cable can use either two “short arc” half-moon-profile insulated conductors to form a cable core, or two “full” half-circle profiles. As shown in FIG. 2, when “full” half-circle profiles are insulated and brought together, the resulting profile 20 is oval rather than circular. One additional extrusion process would be required to create the circular profile needed for the cable core.

On the other hand, two “short arc” half-moon-profile insulated conductors can be sized such that applying the insulation over the wire creates a semi-circular-profile insulated conductor. Fitting these semi-circular conductors together results in a circular profile. The outer polymeric insulation used to hold the two halves together can, therefore, be formed having a substantially even thickness. In cable cores of the same finished size, the short-arc design allows for a larger copper conductor in the same diameter circle. Considering practical dimensions and insulation thicknesses, the amount of copper in the short-arc design can be twice as much as with the full semi-circular design in the same diameter cable. The conductors, such as the conductors 21, 22, may be formed in any suitable profile such that when the conductors 21, 22 are positioned together, the resulting profile is substantially oval or substantially circular. Those skilled in the art will appreciate that more than two conductors, such as the conductors 21, 22 may be utilized to form a core conductor such as the core conductor 20 while remaining within the scope of the embodiments of the cables.

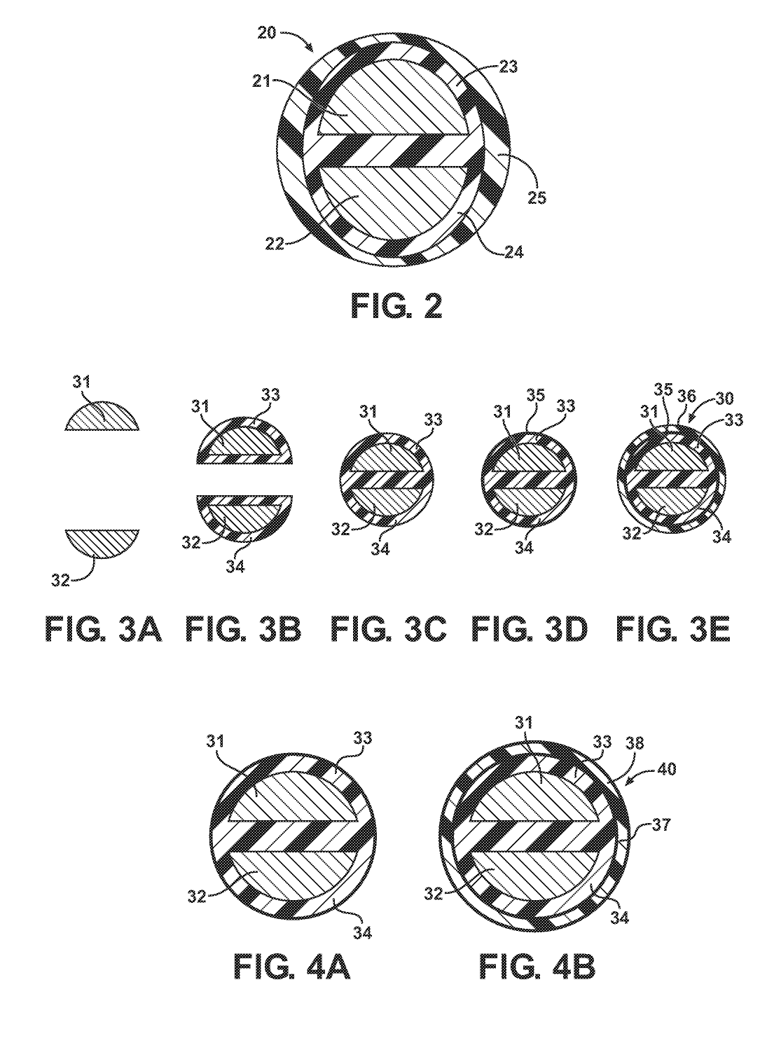

As shown in FIGS. 3A-3E, a second embodiment of a cable core 30 may be constructed as follows by a method beginning with a step “A” with short arc half-moon profile copper conductors 31, 32. Alternatively, the conductors are formed from any suitable electrically conductive material. In a step “B”, a layer of polymeric insulation 33, 34 is extruded over the half-moon-profile conductors 31, 32 respectively resulting in insulated conductors with a full half-circle profile (FIG. 3B). In a step “C”, the two insulated conductors are brought together to create a circular-profile (FIG. 3C). In a step “D”, a layer of cabling tape 35 is applied over the cable core to hold it together. In a step “E”, a layer of polymeric insulation 36 is extruded over the cabling tape 35 to complete the cable core 30.

There is shown in FIGS. 4A and 4B a third embodiment cable core 40 alternative to the cabling tape 35 applied in the Step “D” of FIG. 3D. Instead of the cabling tape 35, in a step “D1” a thin layer of polymer 37 is extruded over the two insulated conductors to hold them in place for a thicker layer of polymeric insulation 38 applied in a Step “E1”.

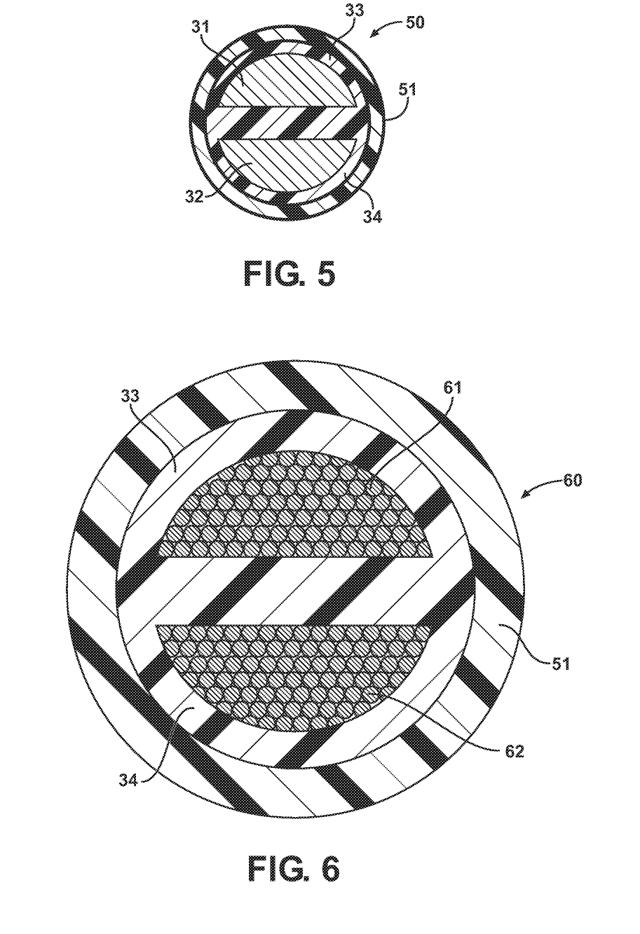

There is shown in FIG. 5 a fourth embodiment cable core 50 additional alternative to the cabling tape 35 applied in Step “D” of FIG. 3D. In a Step “D2”, a thick layer of polymeric insulation 51 is applied directly over the insulated conductors to complete the cable core 50.

Alternatively, a fifth embodiment cable core 60 begins with half-moon compressed shaped copper conductors 61, 62, also known as Milliken conductors, as shown in FIG. 6. The conductors 61, 62 each include a plurality of conductive wires. Alternatively, the conductors are formed from any suitable electrically conductive material. The manufacturing method or process includes the completion alternatives shown in FIGS. 3A-3E, 4 and 5.

In embodiments of the cable cores 20, 30, 40, 50, 60, relatively high amounts of power can be transmitted down one insulated half-moon profile conductor and returned on the other. No power return takes place on the armor wire strength members. The size and shape of the conductors allows sufficient surface area on the conductors to carry relatively high amounts of electrical power. The symmetrical configuration is advantageous for telemetry functions. This configuration also allows room in the cross section for insulation to minimize the risk of electrical shorts.

In another embodiment of a cable core according to the present invention, insulated and non-insulated stranded copper conductors in the cable core are formed in a “triad” configuration, and then applied with an ample amount of insulation over the bundle of conductors to complete the cable core. This embodiment or configuration provides good capabilities for power transmission and return within the cable core, has good telemetry capabilities, and allows for sufficient thicknesses of polymeric insulation to protect the conductors against electrical shorting.

A sixth embodiment of a cable core 70 includes preferably three insulated stranded copper conductors that are cabled in a triad configuration over a conductor insulated with a soft polymer. Alternatively, the conductors are formed from any suitable electrically conductive material. Three un-insulated copper conductors are then cabled into the spaces between the insulated conductors. A relatively thick layer of polymeric insulation is extruded over the top of the cabled conductors to complete the small-diameter cable core 70. The embodiment provides ample conductor surface area to transmit relatively large amounts of power, flexibility in how the assorted conductors may be used for different applications, and a sufficiently thick layer of polymeric insulation over all conductors to protect against potential electrical shorts arising from damage to thin layers of insulation.

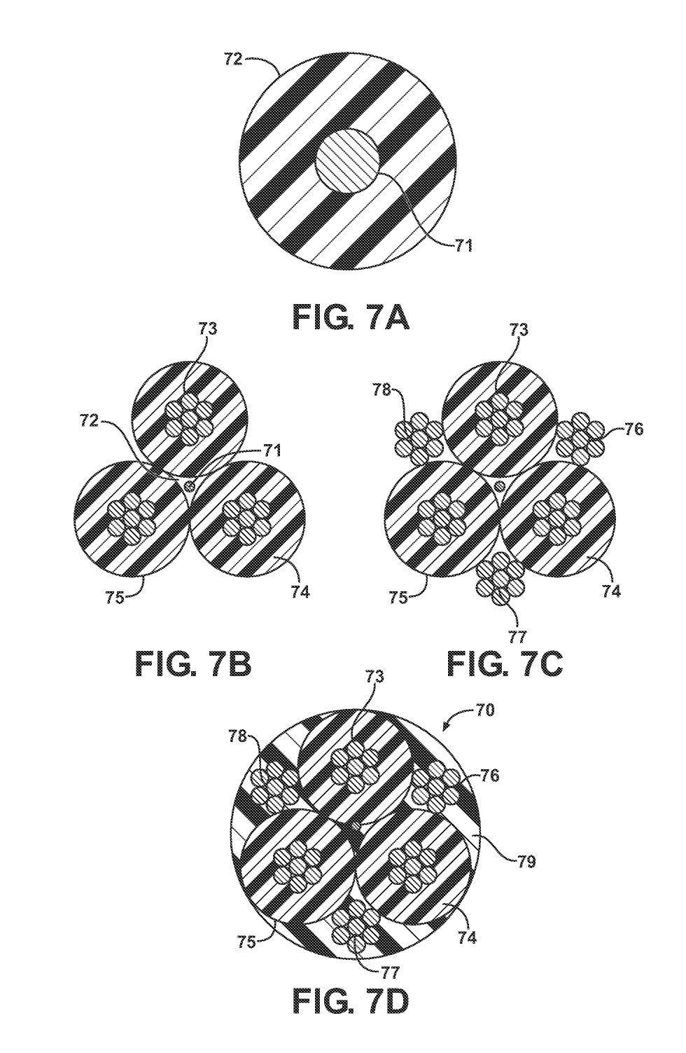

As shown in FIGS. 7A through 7D, the cable core 70 is assembled as follows. In a step “A”, a stranded copper conductor 71 insulated with a soft polymer 72 is placed at the center of the cable core (FIG. 7A). Alternatively, the conductor is formed from any suitable electrically conductive material. In a step “B”, three insulated conductors 73, 74, 75 are cabled helically over the central conductor 71 in a triad configuration (FIG. 7B). The soft polymer 72 on the central conductor 71 deforms to fill the interstitial voids between the central conductor 71 and the insulated conductors 73, 74, 75. In a step “C”, three un-insulated conductors 76, 77, 78 are cabled into the spaces at the outside of the insulated conductors 73, 74, 75 (FIG. 7C). In a step “D”, a relatively thick layer of polymeric insulation 79 is extruded over the bundled conductors to complete the cable core 70 (FIG. 7D).

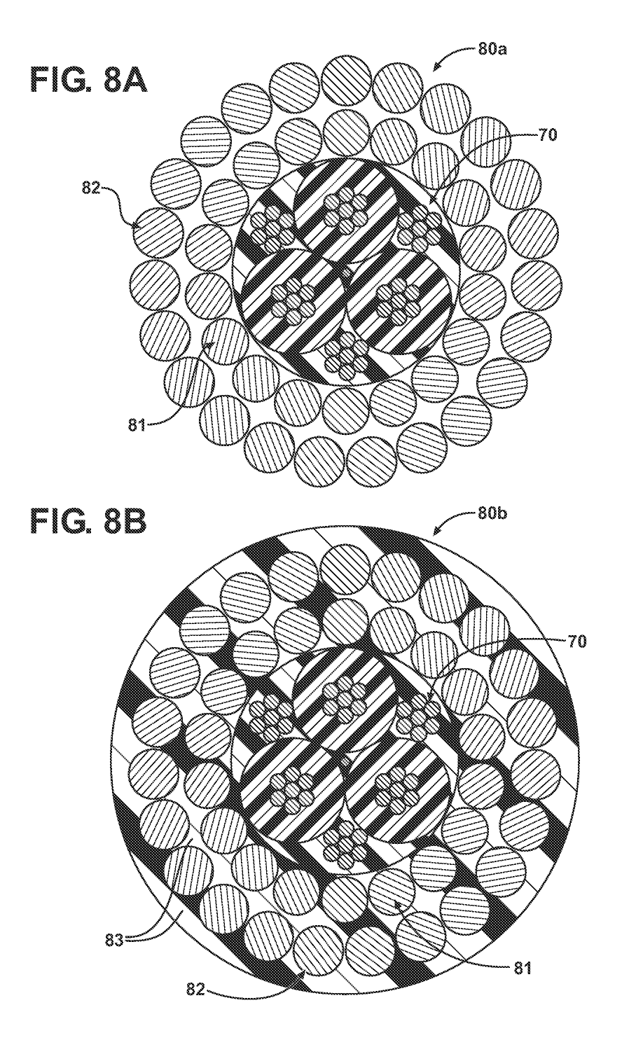

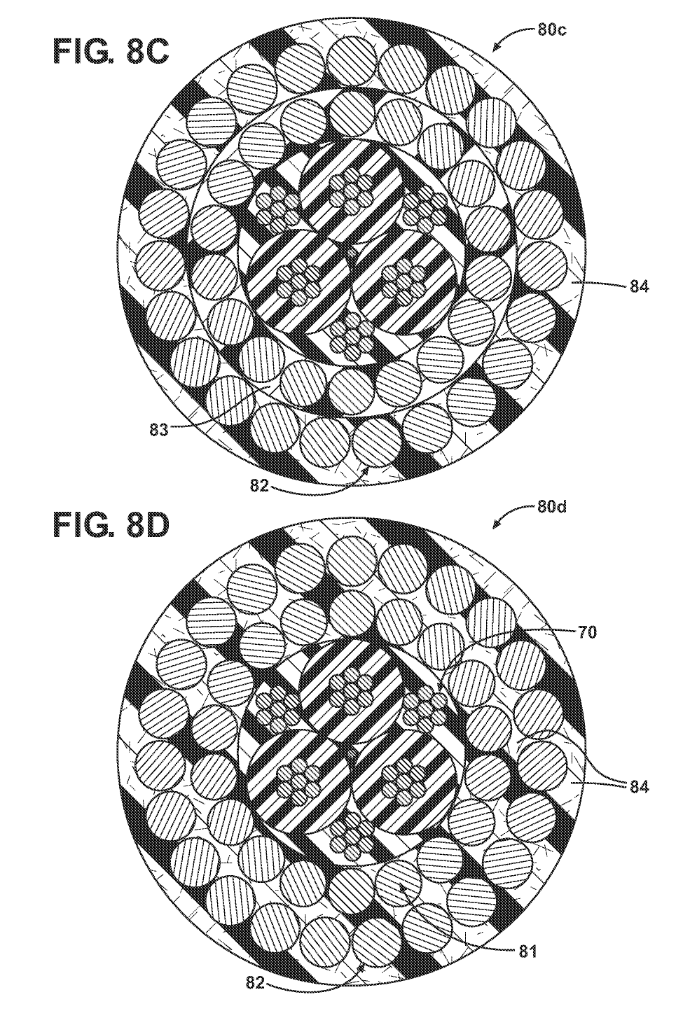

Alternatively, the cable core configurations described above and shown in FIGS. 2 through 7D are completed by applying any of a number of configurations of armor wire layers and jacketing options. In a non-limiting example (as illustrated in FIGS. 8A through 8D), a cable may be completed by applying one of the following systems. In a step “A”, the cable core 70 is provided with two layers of bare, counterhelically cabled armor wire strength members, an inner layer 81 and an outer layer 82, to form a cable 80a. In a step “B”, the cable core 70 is completed with the two layers of counterhelically cabled armor wire strength members 81, 82 encased in layers of pure polymer 83 to form a cable 80b. In a step “C”, the cable core 70 is completed with the two layers of counterhelically cabled armor wire strength members 81, 82 encased in alternating layers of pure 83 and short-fiber-reinforced polymer 84 to form a cable 80c. In a step “D”, the cable core 70 is completed with the two layers of counterhelically cabled armor wire strength members 81, 82 encased entirely in layers of the short-fiber-reinforced polymer 84 to form a cable 80d.

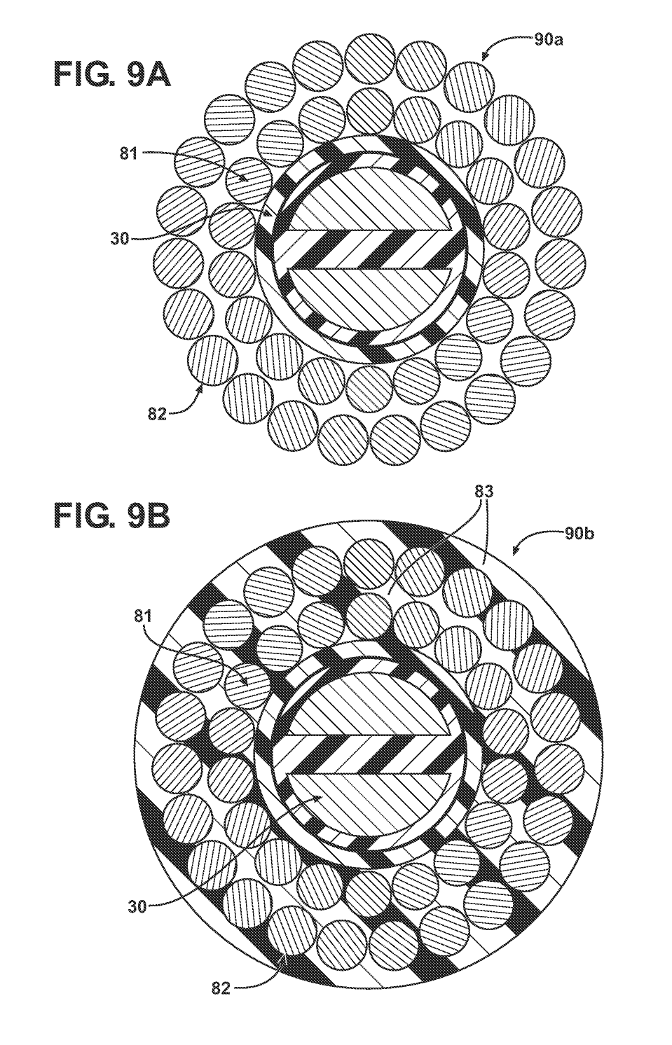

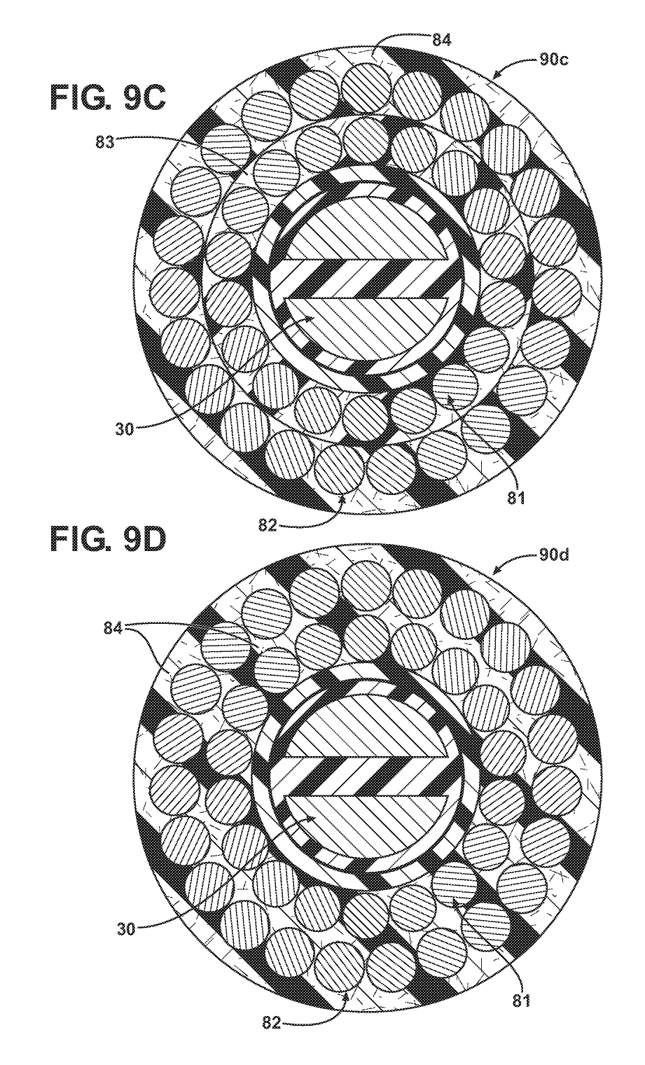

In a similar non-limiting example (as illustrated in FIGS. 9A through 9D), a cable may be completed by applying one of the following systems. In a step “A”, the cable core 30 is provided with two layers of bare, counterhelically cabled armor wire strength members, the inner layer 81 and the outer layer 82, to form a cable 90a. In a step “B”, the cable core 30 is completed with the two layers of counterhelically cabled armor wire strength members 81, 82 encased in the layers of pure polymer 83 to form a cable 90b. In a step “C”, the cable core 30 is completed with the two layers of counterhelically cabled armor wire strength members 81, 82 encased in alternating layers of the pure 83 and the short-fiber-reinforced polymer 84 to form a cable 90c. In a step “D”, the cable core 30 is completed with the two layers of counterhelically cabled armor wire strength members 81, 82 encased entirely in layers of the short-fiber-reinforced polymer 84 to form a cable 90d. Those skilled in the art will appreciate that the cable core 30 of the cable 90d may be replaced with the cable cores 20, 40, 50, or 60, as necessary, such as by design requirements and the like.

The polymeric materials useful in the embodiments of the cables may include, by nonlimiting example, polyolefins (such as EPC or polypropylene), other polyolefins, polyaryletherether ketone (PEEK), polyaryl ether ketone (PEK), polyphenylene sulfide (PPS), modified polyphenylene sulfide, polymers of ethylene-tetrafluoroethylene (ETFE), polymers of poly(1,4-phenylene), polytetrafluoroethylene (PTFE), perfluoroalkoxy (PFA) polymers, fluorinated ethylene propylene (FEP) polymers, polytetrafluoroethylene-perfluoromethylvinylether (MFA) polymers, Parmax®, and any mixtures thereof.

Embodiments of cables provide alternatives to current monocable and coaxial cable designs that are capable of carrying relatively large amounts of power, are more durable, have improved telemetry capabilities, and eliminate potential safety issues related to power return on armor wire strength members.

Embodiments of cables eliminate the potential shock hazard of monocables and are more durable than coaxial cables while providing the ability to deliver approximately two times the amount of power of a typical coaxial cable to a depth of over approximately 30,000 feet while also providing good telemetry capabilities. When formed, embodiments of cables, such as the cables 80a, 80b, 80c, 80d, 90a, 90b, or 90c, are preferably, but are not limited to, small diameter cables having a diameter of about 0.35 inches or less.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values. Accordingly, the protection sought herein is as set forth in the claims below.

We claim:

1. A method of forming a small-diameter wireline cable core, the method comprising:
a. providing at least a pair of conductors;
b. extruding a layer of polymeric insulation over each of the conductors;
c. fixing the layered conductors together with a fixing material to create one of an oval profile and a circular profile; and
d. extruding a layer of polymeric insulation to form a cable core with a circular profile.

2. The method of claim 1 wherein the conductors have one of a half moon profile, a full half-circle profile and a short arc profile.

3. The method of claim 1 wherein the fixing material is cabling tape.

4. The method of claim 1 wherein the fixing material is a polymeric insulation.

5. The method of claim 1 wherein the conductors are formed from a copper material.

6. The method of claim 1 wherein the conductors each include a plurality of conductive wires formed into a half moon profile.

7. The method of claim 1 further comprising completing a cable including the cable core.

8. The method of claim 6 wherein the completing comprises counterhelically cabling at least two layers of bare armor wire strength members over the cable core.

9. The method of claim 7 wherein the completing further comprises encasing the armor wire strength members in one of layers of pure polymer, layers of short-fiber-reinforced polymer, and alternating layers of pure and short-fiber-reinforced polymer.

10. A method of forming a small-diameter wireline cable core, the method comprising:
a. providing a stranded central conductor insulated with a soft polymer material;
b. helically cabling three insulated conductors over the central conductor in a triad configuration;
c. cabling three un-insulated conductors into spaces at an outside of the insulated conductors to form a plurality of bundled conductors; and
d. extruding a layer of polymeric insulation over the plurality of bundled conductors to form the cable core.

11. The method of claim 10 wherein the soft polymer material on the central conductor deforms to fill interstitial voids between the central conductor and the insulated conductors.

12. The method of claim 10 wherein the stranded central conductor is formed from a copper material.

13. The method of claim 10 further comprising completing a cable including the cable core.

14. The method of claim 13 wherein the completing comprises counterhelically cabling at least two layers of bare armor wire strength members over the cable core.

15. The method of claim 14 wherein the completing further comprises encasing the armor wire strength members in one of layers of pure polymer, layers of short-fiber-reinforced polymer, and alternating layers of pure and short-fiber-reinforced polymer.

16. A small-diameter wireline cable core comprising:
one of either two insulated half moon profile conductors fixed together or an insulated central conductor over which three insulated conductors are helically cabled in a triad configuration; and
a layer of polymeric insulator covering all of said conductors to form a circular profile.

17. The cable core according to claim 16 wherein said two insulated half moon profile conductors are fixed together with cabling tape.

18. The cable core according to claim 16 including three un-insulated conductors cabled into spaces at an outside of the insulated conductors to form a plurality of bundled conductors.

19. An electrical cable including said cable core according to claim 16, further comprising at least two layers of bare armor wire strength members counterhelically cabled over said cable core.

20. The electrical cable according to claim 19 wherein said armor wire strength members are encased in one of layers of pure polymer, layers of short-fiber-reinforced polymer, and alternating layers of pure and short-fiber-reinforced polymer.
